(19) United States
(12) Patent Application Publication
(10) Pub. No.: US 2010/0031353 A1
(43) Pub. Date: Feb. 4, 2010

(54) Malware Detection Using Code Analysis and Behavior Monitoring

(75) Inventors: Anil Francis Thomas, Redmond, WA (US); George Cristian Chicioreanu, Redmond, WA (US); Adrian Mihail Marinescu, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/025,694

(22) Filed: Feb. 4, 2008

(51) Int. Cl. G06F 11/00

(52) U.S. Cl. 726/22; 718/1

(57) ABSTRACT

Aspects of the subject matter described herein relate to malware detection using code analysis and behavior monitoring. In aspects, an anti-malware engine performs static analysis on program code and monitors behavior of the program code that is exhibited when the program code executes in a virtual and/or non-virtual environment. The anti-malware engine combines the results of both types of malware detection to determine whether the program code includes malware. The anti-malware engine may use feedback from one or more of the malware detection mechanism to direct additional malware detection (e.g., static and/or behavior detection) for the program code.

### BACKGROUND

In one sense, malware includes unwanted software that is installed on a computer. Malware may be hostile, intrusive, or annoying. It may be designed to infiltrate or damage a computer system without the owner's informed consent. Malware can be relatively benign or severely disruptive. Some malware can spread from computer to computer via networks or the use of removable computer-readable media. Some malware attempts to remain hidden from user inspection while other malware becomes obvious immediately.

The number of malware continues to grow at a phenomenal rate. Vendors that produce malware detection and removal products are continually updating the list of malware their products can detect and remove. Guarding against malware is an ongoing challenge.

### SUMMARY

Briefly, aspects of the subject matter described herein relate to malware detection using code analysis and behavior monitoring. In aspects, an anti-malware engine performs static analysis on program code and monitors behavior of the program code that is exhibited when the program code executes in a virtual and/or non-virtual environment. The anti-malware engine combines the results of both types of malware detection to determine whether the program code includes malware. The anti-malware engine may use feedback from one or more of the malware detection mechanism to direct additional malware detection (e.g., static and/or behavior detection) for the program code.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that generally represents one exemplary embodiment of the anti-malware engine 230 of FIG. 2 in accordance with aspects of the subject matter described herein; and

FIG. 4 is a flow diagram that general represents actions that may occur in detecting malware in accordance with aspects of the subject matter described herein.

### DETAILED DESCRIPTION

### Exemplary Operating Environment

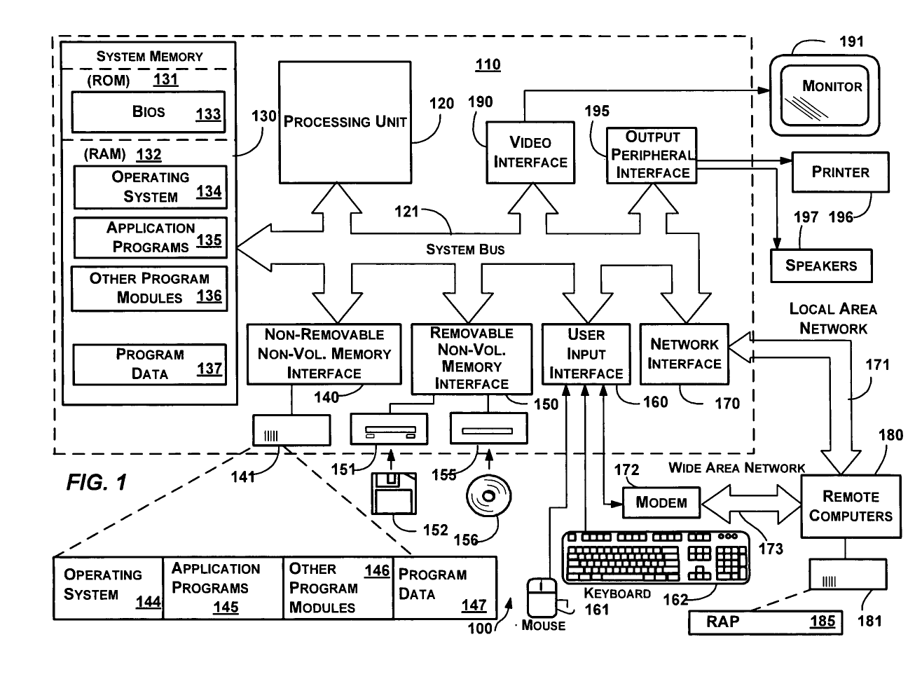

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Malware Detection

As mentioned previously, malware is a significant problem to computer systems. In one embodiment, malware may include computer viruses, worms, Trojan horses, spyware, unwanted adware, other malicious or unwanted software, and the like. In another embodiment, malware may include software that presents material that is considered to be obscene, lewd, lascivious, filthy, excessively violent, harassing, or otherwise objectionable.

The primary mechanism by which an anti-malware product (antivirus or antispyware) detect malware is by matching the binary code of the malware against a “signature.” The signature may be as simple as a hash of the binary. However, this approach may be defeated by malware authors through modifications to the binary.

Malware authors also make it more difficult for anti-malware software to detect the malware by packing (encoding) the binary, encrypting the binary, rearranging parts of the binary, some combination of the above, and the like. A packed binary may have millions or more variations and may be packed and/or encrypted multiple times. When an encoded malware executes, it will unpack itself and then execute the malicious code. Anti-malware vendors may counter this attack by introducing emulation, which allows a computer to emulate the malware in a virtual environment to unpack itself. After the malware is unpacked, malware detection software may then use a signature to match the original malware.

A virtual environment is an environment that is simulated or emulated by a computer. The virtual environment may simulate or emulate a physical machine. This machine that is simulated or emulated is sometimes called a virtual machine. A virtual machine is a machine that, to software executing on the virtual machine, appears to be a physical machine. The software may save files in a virtual storage device such as virtual hard drive, virtual floppy disk, and the like, may read files from a virtual CD, may communicate via a virtual network adapter, and so forth.

More than one virtual machine may be hosted on a single computer. That is, two or more virtual machines may execute on a single physical computer. To software executing in each virtual machine, the virtual machine appears to have its own hardware even though the virtual machines hosted on a single computer may physically share one or more physical devices with each other and with the hosting operating system.

Emulation has its limits. For example, it may not be possible to emulate an operating system environment perfectly. In addition, resource and time constraints may prevent anti-malware products from emulating every binary thoroughly.

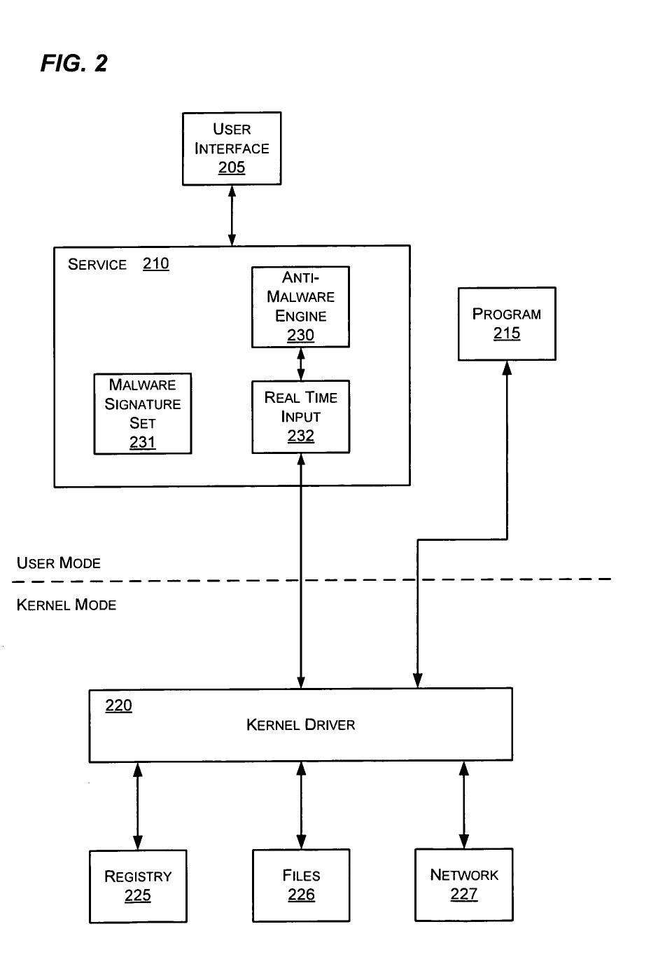

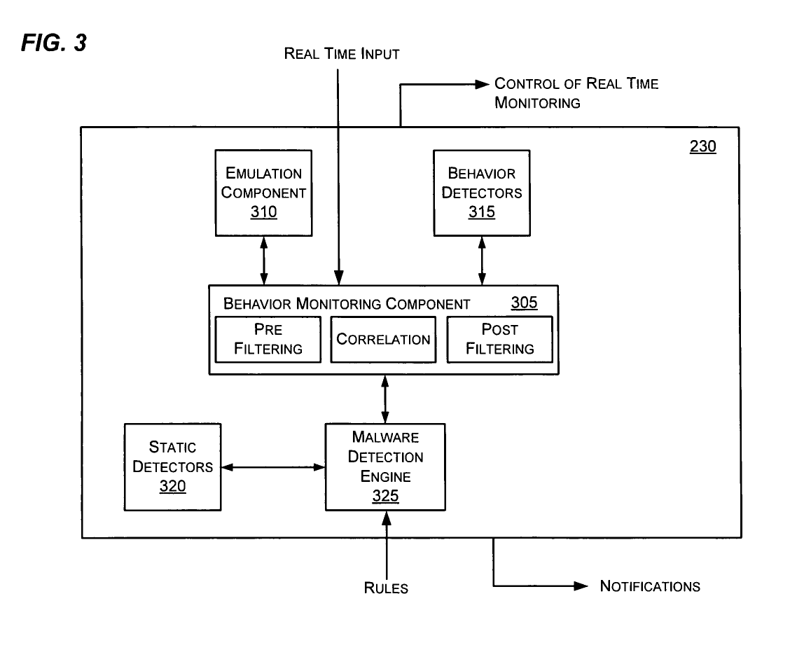

FIGS. 2-3 are block diagram illustrating various components that may be included in an apparatus arranged in accordance with aspects of the subject matter described herein. The components illustrated in FIGS. 2-3 are exemplary and are not meant to be all-inclusive of components that may be needed or included. In other embodiments, the components or functions described in conjunction with FIGS. 2-3 may be included in other components or placed in subcomponents without departing from the spirit or scope of aspects of the subject matter described herein.

FIG. 2 is a block diagram representing an exemplary environment in which aspects of the subject matter described herein may be implemented. The environment may include a user interface 205, a service 210, a program 215, a kernel driver 220, and resources 225-227. The service 210 may include an anti-malware engine 230, a malware signature set 231, and a real time input component 232.

The service 210 hosts an anti-malware engine 230 that determines whether a program (e.g., the program 215) is malware. In making this determination, the anti-malware engine 230 may use static properties of the program and behavior of the program. Static properties include properties of a program that can be determined without executing the program. Some exemplary static properties include the libraries to which a program links, the name of the program, its size, its version number, APIs a program imports, references to APIs (e.g., API calling code) included in the program, a hash of a portion or the entire program, an encryption algorithm, if any, by which the program has been encrypted, metadata about the program, a pattern included in the program, and the like.

For example, the encryption algorithm by which a program has been encrypted may increase the confidence that the program is malware if the encryption algorithm is often used for other malware. As another example, malware often has an irregular version number. Thus, having an irregular version number may increase the confidence that the program is malware.

The set of properties that defines a particular malware is sometimes referred to as a signature of the malware. A set of properties may also define a set of more than one malware. In this case, the signature of the set of properties may indicate that a malware of the set is present. Malware signatures may be stored in the malware signature set 231 which may be updated periodically.

Behavior of a program includes what a program does when it is executed. Behavior may include injection into another process, sending data to the network, downloading other programs, modifying the registry (e.g., adding a class ID), modifying one or more files, creating one or more files, where the process creates and/or modifies files (e.g., files in a system directory), modifying locations in memory, and the like. Behavior may be monitored by executing the program in a virtual environment such a virtual operating system and monitoring the program's behavior, by executing the program in the real operating system and monitoring the program's behavior, by a combination of the above, and the like. In one embodiment, the anti-malware engine 230 may not directly execute the program in the real operating system but may allow the operating system to execute the program after doing static and/or dynamic analysis.

The anti-malware engine 230 may use the static properties and/or behavior of the program to determine whether the program is malware. The anti-malware engine 230 may assign confidences levels to one or more properties and behaviors of the program and may combine confidence levels (e.g., according to rules) to determine whether the program is malware.

The anti-malware engine 230 may use feedback to determine that others actions are to be taken in determining whether the program is malware. For example, if the confidence level obtained via static property analysis is over a threshold, the anti-malware engine 230 may cause the program to be emulated more extensively in a virtual environment to determine whether the program is malware. If the behavior during emulation or real time execution increases the confidence level above a threshold, the anti-malware engine 230 may cause more rigorous static analysis to be performed on the program.

The kernel driver 220 monitors changes to the resources 225-227 made by the program 215. The resources 225-227 may include, for example, a portion of a registry or other data base, files or other object of a file system, data sent or received from a network, a portion of memory, and the like.

The kernel driver 220 may be configured to notify the real time input component 232 when predefined resources are accessed by the program 215. For example, if the program 215 adds a class ID to the registry 225, the kernel driver 220 may notify the real time input component 232 that a class ID has been created. The kernel driver 220 may also include additional information, if desired, such as which class ID was created or what registry values were changed.

If files within a system directory are changed by the program 215, the kernel driver 220 may notify the real time input component 232 and provide the files changed. If other monitored files are changed (e.g., a partition table, boot information, other sensitive files, and the like) by the program 215, the kernel driver 220 may notify the real time input component 232 of the change.

The kernel driver 220 may be configured to notify the real time input component 232 if the program 215 downloads certain binaries from the network. If the application downloads one or more of these binaries, the kernel driver 220 may notify the real time input component 232 and indicate the binaries downloaded.

The kernel driver 220 may be configured to notify the real time input component 232 if the program 215 modifies or attempts to modify certain locations in memory. For example, the program 215 may attempt to modify memory to gain access to sensitive resources. If the program modifies the certain locations in memory, the kernel driver 220 may notify the real time input component 232 and indicate the memory that has been modified.

The behaviors that the kernel driver 220 may monitor that are mentioned above are intended to be exemplary and not all-inclusive or exhaustive. In some embodiments, the kernel driver 220 may monitor any designated behavior of the program 215. The behaviors and/or resources that the kernel driver 220 monitors may be configured via the real time input component 232.

If the anti-malware engine 230 determines that a program is or is likely malware, the service 210 may notify a user via the user interface 205. A user interacting with the user interface 205 may instruct the service 210 to perform various actions in response. In another embodiment, an administrative process may automatically take one or more actions without any user interaction. Such actions may include, for example, stopping the program, putting the program in quarantine, allowing the program to continue executing, other actions, and the like.

The program 215 may include one or more executables, libraries, scripts, processes, threads, and the like. In one embodiment, the program 215 comprises any thread, process, instructions, or the like that are capable of being executed by a computer (e.g., such as the computer 110 of FIG. 1).

Although the entities illustrated in FIG. 2 are illustrated as being in user mode or in kernel mode, in other embodiments, one or more of the entities that are shown as being in user mode may be in kernel mode and vice versa. Furthermore, in some embodiments, one or more of the entities that are illustrated as being in user or kernel mode may be distributed in both user and kernel mode such that a portion of the entity (and/or its functions) executes in kernel mode and a portion of the entity (and/or its functions) executes in user mode.

FIG. 3 is a block diagram that generally represents one exemplary embodiment of the anti-malware engine 230 of FIG. 2 in accordance with aspects of the subject matter described herein. The malware engine 230 may include an emulation component 310, behavior detector(s) 315, a behavior monitoring component 305, static detectors 320, and malware decider 325. The emulation component 310 may initiate and stop an emulation environment in which a program may execute.

The behavior detector(s) 315 may configure external detection components (e.g., the kernel driver 220) and determine the behavior that a program is exhibiting based on input received from the external detection components.

The static detectors 320 may analyze static properties of a program in an attempt to match the properties to a signature, for example.

The behavior monitoring component 305 may include pre filtering, correlation, and post filtering subcomponents. The pre filtering component may filter out behaviors that are not deemed to be indicative of malware activity. The correlation component may correlate activity with malware activity. The post filtering may apply rules to determine when identified and correlated activity is not sufficient to be considered possible malware activity.

The malware detection engine 325 may take input from the static detectors 320 and the behavior monitoring component 305 and may make a determination as to whether a program is malware. In making this determination, the malware decider 325 may be driven by rules. These rules may specify conditions that must exist before a program is considered malware. For example, a rule may state that if the static detector has detected an irregular version number and the behavior monitoring component has detected registry modification, that this indicates that the program is suspect to be malware and needs to be further emulated or to be sent back for more rigorous static detection. As another example, a rule may state that if the program was encrypted with a particular encryption algorithm and is attempting to download files from a particular server, that the program is suspected to be malware and is to be further analyzed.

A rule may also specify what additional activities are to be performed, if any, to determine whether a program is malware. These additional activities may be triggered when the conditions of the rule are met.

If a program is determined to be malware or likely to be malware, the anti-malware engine 230 may send notifications to users, system administrators, programs that have subscribed to be notified, and the like. A backend server may be notified if a program is determined to be malware. A anti-malware vendor may use this information to locate the malware and create a signature for the malware to use in updating the malware signature sets on one or more other machines.

The malware decider 325 may determine that additional real time and/or emulation monitoring is to be performed and/or that more static analysis is to be performed. In response, the anti-malware engine may continue or increase the level of real time monitoring, emulation, and/or static analysis.

The malware decider 325 (or the components doing the malware analysis) may direct the type of additional malware detection that is to be performed on a program. For example, the malware decider 325 may, based on various inputs from various modules, determine that static analysis that searches for certain types of API calls be performed, that certain types of network activities are to be further monitored, that other portions of a registry or file system are to be monitored for changes, and the like. The direction of the additional malware detection may be determined based on the rules.

A data structure that tracks what has been discovered about a program may be created and maintained. This data structure may be passed or otherwise made available to each of the components of the anti-malware engine 230. A component may use the data structure to modify its detection behaviors and may also update the data structure as additional information is discovered about the program.

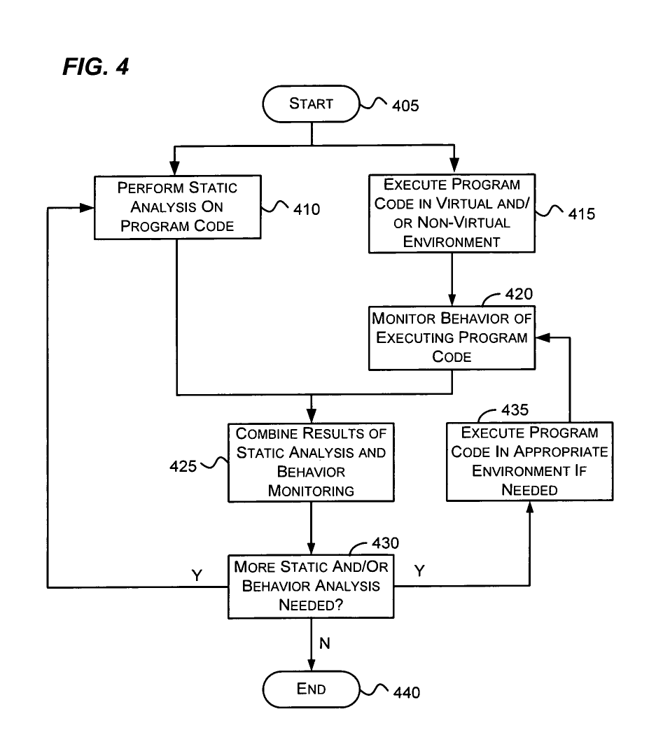

FIG. 4 is a flow diagram that general represents actions that may occur in detecting malware in accordance with aspects of the subject matter described herein. For simplicity of explanation, the methodology described in conjunction with FIG. 4 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410 static analysis is performed on program code. For example, referring to FIG. 3, the static detectors 320 perform static analysis on program code that may include malware.

At block 415 the program code is executed in a virtual and/or non-virtual environment. For example, referring to FIG. 3, the emulation component 310 may start a virtual environment (e.g., a virtual operating system) and execute the program code in the virtual environment. As another example, referring to FIG. 2, the service 210 may instruct the kernel driver 220 to allow the program 215 to execute in a non-virtual (e.g., the real) operating system.

At block 420, behavior of the executing program code is monitored. For example, referring to FIG. 3, the behavior monitoring component 305 may monitor the behavior (from virtual and/or non-virtual execution) of the program code.

At block 425, results obtained during static analysis and behavior monitoring is combined. For example, referring to FIG. 3, the malware decider 325 may combine results from the static detectors and the behavior monitoring component. In another embodiment, a single data structure is used by both static analysis components and behavior analysis components.

At block 430, a determination is made as to whether more static and/or behavior analysis is needed. If so the actions continue at block 410 and/or block 435. For example, referring to FIG. 3, the malware decider 325 may determine that additional behavior analysis and/or static analysis is needed to determine whether the program code is malware.

At block, 435, the program code is executed in the appropriate environment for behavior monitoring if the program code is not already executing in that environment. For example, if the program code has been executing in a virtual environment and is now to be executed in a non-virtual environment, the program code is executed in the non-virtual environment. If the program code has been executing in a non-virtual environment and is now to be also be executed in a virtual environment, the emulation component 310 may initialize the virtual environment, if needed, and execute the program code in the virtual environment.

At block 440, the actions end.

Note that the actions associated with blocks 410 and 415 and 420 may be performed in parallel. Also note that the combination of results at block 425 may be performed at any time and that the actions associated with block 430 may also be performed at any stage in the method of FIG. 4.

As can be seen from the foregoing detailed description, aspects have been described related to malware detection using code analysis and behavior monitoring. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
examining program code for properties that potentially indicates malware and maintaining first data based thereon;
executing the program code;
monitoring behavior of the program code while it is executing and maintaining second data based thereon; and
using at least the first data with the second data to determine whether the program code includes malware.

2. The method of claim 1, wherein examining the program code for properties that potentially indicates malware comprises identifying properties of the program code and comparing these properties with a signature of known malware.

3. The method of claim 1, wherein executing the program code comprises creating a virtual operating system and executing the program code within the virtual operating system.

4. The method of claim 1, wherein executing the program code comprises executing the program code in a non-virtual operating system.

5. The method of claim 1, wherein monitoring behavior of the program code while it is executing comprises determining whether the program code accesses a certain resource.

6. The method of claim 5, wherein the resource comprises a registry associated with an operating system.

7. The method of claim 5, wherein the resource comprises an object of a file system.

8. The method of claim 5, wherein the resource comprises a network resource.

9. The method of claim 1, wherein using at least the first data and the second data to determine whether the program code includes malware comprises applying a rule, the rule specifying a condition that must be met to determine that the program code includes malware.

10. The method of claim 1, wherein neither the first data alone nor the second data alone is sufficient to determine that the program code includes malware, but wherein the data within the first data structure combined with the data in the second data structure is sufficient to determine that the program code includes malware.

11. A computer storage medium having computer-executable instructions, which when executed perform actions, comprising:
examining static properties of computer code in an attempt to identify whether the computer code includes malware, the examining static properties obtaining first results;
examining behavior of the computer code that is exhibited while the computer code is executing in an attempt to identify whether the computer code includes malware, the examining behavior obtaining second results; and
using at least the first and second results to determine whether more examining is to be performed to attempt to identify whether the computer code includes malware.

12. The computer storage medium of claim 11, wherein the more examining comprises further examining the static properties of the computer code.

13. The computer storage medium of claim 11, wherein the more examining comprises executing the computer code in a virtual operating system and examining behavior therein in conjunction with continuing to examine behavior of the computer code as it is executing in a non-virtual operating system.

14. The computer storage medium of claim 11, further comprising also using a rule having conditions specified therein, the rule indicating if the more examining is to be performed based at least in part on one or more of the first and second results.

15. The computer storage medium of claim 11, wherein examining static properties of the computer code comprises obtaining properties of the compute code obtainable without executing the computer code.

16. The computer storage medium of claim 11, wherein examining behavior of the computer code that is exhibited while the computer code is executing comprises monitoring resources accessed by the computer code while the computer code is executing in a virtual environment.

17. The computer storage medium of claim 11, wherein examining behavior of the computer code that is exhibited while the computer code is executing comprises monitoring resources accessed by the computer code while the computer code is executing in a non-virtual environment.

18. In a computing environment, an apparatus, comprising:
a static detector operable to obtain static properties associated with a program code, the static properties related to whether the program code includes malware, the static detector operable to update first data related to malware detection based on the static properties;
a behavior monitor operable to detect behavior exhibited by the program code while the program is executing, the behavior monitor further operable to update second data related to malware detection based on the behavior exhibited by the program code; and
a malware detection engine operable to determine whether the program code includes malware based at least on the first and second data and one or more rules.

19. The apparatus of claim 18, wherein the static detector is operable to perform additional static analysis of the program code based at least in part on the one or more rules and the second data.

20. The apparatus of claim 18, wherein the behavior monitor is operable to perform additional behavior monitoring of the program code based at least in part on the one or more rules and the first data.
